(19) United States
(12) Patent Application Publication
(10) Pub. No.: US 2012/0295169 A1
(43) Pub. Date: Nov. 22, 2012

(54) AIR BATTERY AND ELECTRODE

(75) Inventors: Akihisa HOSOE, Osaka-shi (JP); Kazuki OKUNO, Osaka-shi (JP); Koutarou KIMURA, Osaka-shi (JP); Kengo GOTO, Osaka-shi (JP); Hideaki SAKAIDA, Osaka-shi (JP); Junichi NISHIMURA, Imizu-shi (JP)

(73) Assignees: SUMITOMO ELECTRIC TOYAMA CO., LTD., Imizu-shi (JP); SUMITOMO ELECTRIC INDUSTRIES, LTD., Osaka-shi (JP)

(21) Appl. No.: 13/495,363

(22) Filed: Jun. 13, 2012

Related U.S. Application Data
(63) Continuation of application No. PCT/JP2012/053276, filed on Feb. 13, 2012.

(30) Foreign Application Priority Data
Feb. 18, 2011 (JP) 2011-032703
Dec. 26, 2011 (JP) 2011-282627

(51) Int. Cl. H01M 12/06

(52) U.S. Cl. 429/405

(57) ABSTRACT

Provided is a structure for effectively utilizing a novel metal porous body, such as an aluminum porous body, having a three-dimensional network structure as a battery electrode.

An air battery that uses oxygen as a positive electrode active material includes an aluminum porous body having a three-dimensional network structure, the aluminum porous body functioning as a positive electrode collector, wherein an electrode that includes a positive electrode layer containing a catalyst and a binder and provided on a surface of a skeleton of the aluminum porous body is used. Furthermore, provided are an electrode having continuous pores in a state where a positive electrode layer is provided on a surface of a skeleton of an aluminum porous body, an electrode having a continuous hollow portion inside a skeleton thereof, and an air battery including any of the electrodes.

### CROSS REFERENCES TO RELATED APPLICATIONS

This application is a Continuation of International Patent Application No. PCT/JP2012/053276, filed Feb. 13, 2012, which claims the benefit of Japanese Patent Application No. 2011-032703 filed in the Japan Patent Office on Feb. 18, 2011 and Japanese Patent Application No. 2011-282627 filed in the Japan Patent Office on Dec. 26, 2011, the entire contents of these applications being incorporated herein by reference.

### TECHNICAL FIELD

The present invention relates to an air battery in which an aluminum porous body is used as a collector, and an electrode thereof.

### BACKGROUND ART

Metal porous bodies having a three-dimensional network structure have been used in various applications such as filters, catalyst supports, and battery electrodes. For example, Celmet (manufactured by Sumitomo Electric Industries, Ltd.: registered trademark) composed of nickel has been used as an electrode material of a battery such as a nickel-hydrogen battery or a nickel-cadmium battery. Celmet is a metal porous body having continuous pores, and has a feature that the porosity is higher (90% or more) than that of other porous bodies such as metal nonwoven fabrics. Celmet is produced by forming a nickel layer on a skeleton surface of a resin foam body having continuous pores, such as a polyurethane foam, decomposing the resin foam body by heat treatment, and conducting a reduction treatment on the nickel. The nickel layer is formed by performing a conductive treatment by applying a carbon powder or the like on the skeleton surface of the resin foam body, and then depositing nickel by electroplating.

Regarding the applications of aluminum to batteries, for example, an aluminum foil having an active material, such as lithium cobalt oxide, on a surface thereof has been used as a positive electrode of a lithium battery. In order to increase the capacity of a positive electrode, an aluminum material may be processed into a porous body so as to have a large surface area, and the inside of the aluminum porous body may be filled with an active material. In this case, the active material can be utilized even in an electrode having a large thickness, and the utilization ratio of the active material per unit area can be improved.

A method for producing an aluminum porous body to which a method for producing a nickel porous body is applied has also been developed. For example, PTL2 discloses the production method. Specifically, PTL1 discloses “a method for producing a metal porous body including forming, on a skeleton of a resin foam having a three-dimensional network structure, a film of a metal that forms a eutectic alloy at the melting point of Al or lower by a plating method or a gas-phase method such as a vapor deposition method, a sputtering method, or a chemical vapor deposition (CVD) method; then impregnating and coating the resin foam having the film thereon with a paste containing, as main components, an Al powder, a binder, and an organic solvent; and conducting heat treatment at a temperature of 550° C. or higher and 750° C. or lower in a non-oxidizing atmosphere”.

### CITATION LIST

### Patent Literature

PTL 1: Japanese Unexamined Patent Application Publication No. 8-170126

### SUMMARY OF INVENTION

### Technical Problem

Aluminum porous bodies in the related art had problems when adopted as a collector of a battery electrode. Specifically, among aluminum porous bodies, aluminum foamed bodies have closed pores because of characteristics of the production method thereof. Accordingly, even when the surface area of an aluminum foamed body is increased by foaming, the entire surface of the aluminum foamed body cannot be effectively utilized. Next, the aluminum porous body described above has a problem that, in addition to aluminum, a metal that forms a eutectic alloy with aluminum is inevitably contained.

The present invention has been made in view of the above problems. An object of the present invention is to provide a structure for effectively utilizing a novel aluminum porous body under being developed by the inventors of the present application as a battery electrode, and to provide an air battery with a high efficiency.

### Solution to Problem

The inventors of the present application are intensively developing an aluminum structure that has a three-dimensional network structure and that can also be widely used in batteries including lithium secondary batteries. A process for producing the aluminum structure includes imparting electrical conductivity to a surface of a sheet-like foam of polyurethane, melamine resin, or the like having a three-dimensional network structure, conducting aluminum plating on the surface, and then removing the polyurethane, the melamine resin, or the like.

An invention of the present application provides an air battery that uses oxygen as a positive electrode active material, the air battery including, as a positive electrode collector, an aluminum porous body having a three-dimensional network structure.

As positive electrode collectors used in existing air batteries, besides pore-free metal plates, conductive substrates (such as a mesh, a punched metal, and an expanded metal) having pores for the purpose of allowing oxygen to permeate have been studied. Unlike these existing porous bodies, the positive electrode collector used in the present invention has a three-dimensional network structure having a large space due to a three-dimensionally continuous skeleton. Thus, the positive electrode collector used in the present invention is very advantageous in the support of a positive electrode layer, the permeation of oxygen, an increase in the contact area between oxygen and a positive electrode catalyst substance, etc.

In particular, a positive electrode including a positive electrode layer provided on a surface of a skeleton of the aluminum porous body is preferably used. In this case, features of the three-dimensional network structure can be utilized, and a large amount of positive electrode layer can be supported. Furthermore, the positive electrode is preferably a porous body electrode forming a three-dimensional network structure in a state where the positive electrode is covered with the positive electrode layer. Specifically, the positive electrode is preferably a porous structure having continuous pores in a state where the positive electrode layer is provided on the surface of the skeleton. By utilizing features that the skeleton has a very large surface area and that oxygen passes through gaps in network, the positive electrode layer can be effectively utilized. The positive electrode layer contains, as main components, a catalyst, a conducive aid such as carbon, and a binder.

The aluminum porous body preferably has a porosity of 90% or more and less than 99%. With such a high porosity, the aluminum porous body can further have network spaces while supporting a sufficient amount of positive electrode layer on the surface of the skeleton. Thus, it is possible to sufficiently ensure the contact between oxygen and the positive electrode layer.

The positive electrode layer provided on the surface of the skeleton preferably has a thickness of 1 μm or more and 50 μm or less. When the thickness of the positive electrode layer is smaller than 1 μm, the amount of positive electrode layer functioning as the positive electrode layer is excessively small. When the thickness of the positive electrode layer exceeds 50 μm, although the positive electrode layer functions on the surface, the distance from the surface of the positive electrode layer to the aluminum porous body functioning as a collector is large, and this is disadvantageous in terms of the movement of electrons. Furthermore, from the standpoint of the relationship with the diameters of pores of the aluminum porous body having a three-dimensional network structure, when the positive electrode layer has an excessively large thickness and the pores are left after the formation of the positive electrode layer, the network spaces, which are the pores, become excessively narrow. This is disadvantageous in terms of intake of oxygen. More preferably, the lower limit is 5 μm or more, and the upper limit is 30 μm or less.

The aluminum porous body may have a continuous hollow portion inside the skeleton thereof. In this case, oxygen can be taken into the positive electrode layer through the inside of the skeleton. This structure is particularly preferable for an air battery.

The electrode of the present invention can be used in a lithium air battery in which metallic lithium is used as a negative electrode active material. In the case where lithium titanate (LTO) is used as a negative electrode, an aluminum porous body having a three-dimensional network structure can also be used as a negative electrode collector. Thus, a further improvement in the battery performance can be expected.

The present application provides an electrode used in an air battery, the electrode including a collector composed of an aluminum porous body having a three-dimensional network structure and a positive electrode layer supported on a surface of the collector. The electrode is preferably a porous body electrode having continuous pores in a state where the positive electrode layer is provided on the surface of a skeleton of the aluminum porous body. The aluminum porous body preferably has a continuous hollow portion inside the skeleton thereof. Furthermore, the aluminum porous body preferably has a porosity of 90% or more and less than 99%, and the positive electrode layer preferably has a thickness of 1 μm or more and 50 μm or less.

### Advantageous Effects of Invention

According to the present invention, it is possible to obtain a battery in which an aluminum porous body is effectively utilized in a battery electrode, and to provide an air battery with high efficiency.

### BRIEF DESCRIPTION OF DRAWINGS

FIG. 1 is a schematic view illustrating a basic structure of an air battery according to the present invention.

FIG. 2 is a photograph showing a structural example of an aluminum porous body used in the present invention.

FIG. 3 is a schematic cross-sectional view illustrating a structure of a positive electrode according to the present invention.

FIG. 4 is a schematic cross-sectional view taken along line A-A in FIG. 3 and illustrating a structure of a cross section of the skeleton of the positive electrode according to the present invention.

FIG. 5 is a flowchart for explaining an example of steps of producing an aluminum porous body used in the present invention.

FIG. 6 includes schematic cross-sectional views illustrating an example of steps of producing an aluminum porous body used in the present invention.

### DESCRIPTION OF EMBODIMENTS

Embodiments of the present invention will now be described with reference to the drawings. It is to be understood that the scope of the present invention is not limited to these embodiments, but is defined by the description of Claims and includes equivalence of the description in Claims and all modifications within the scope of Claims. Specifically, the air battery of the present invention can be applied not only to examples of the structures described below but also to the structures of known air batteries as long as the air batteries include a positive electrode collector composed of an aluminum porous body having a three-dimensional network structure.

### (Structure of Air Battery)

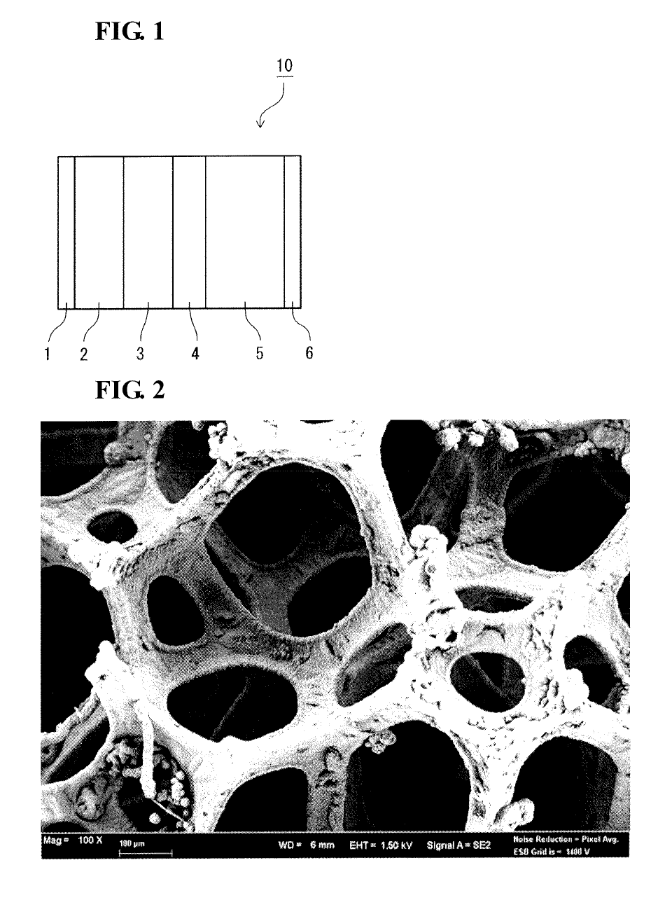

FIG. 1 is a view illustrating a basic structural example of an air battery according to the present invention. The battery has an overall structure in which a negative electrode collector 1, a negative electrode active material 2, an electrolyte solution 3, a separator 4, a positive electrode 5, and an oxygen permeable membrane 6 are stacked in that order. A case, a leading electrode, etc. are also necessary as in a typical battery, but these components are not illustrated or described in this embodiment. An air battery in which metallic lithium is used as the negative electrode active material 2 will now be described as an example. Also in the case where other materials are used, for example, in the case of a zinc air battery or the like, the same advantages as those of this air battery can be achieved by using the electrode of the present invention.

The negative electrode collector 1 is not particularly limited as long as the negative electrode collector 1 has electrical conductivity. Examples of the negative electrode collector 1 include stainless steel, nickel, and carbon. Aluminum can also be used when lithium titanate is used as the negative electrode active material 2.

The positive electrode and the negative electrode are separated by the ion-conductive separator 4 and the electrolyte solution 3. In the case where metallic lithium is used as the negative electrode active material, it is necessary to use an organic electrolyte solution as the electrolyte solution. The electrolyte contained in the electrolyte solution is not particularly limited as long as lithium ions are formed in the electrolyte solution. Any solvent known as an organic solvent used in this type of battery can be used.

The separator 4 has a function of electrically separating the positive electrode and the negative electrode. For example, a porous film containing polyethylene, polypropylene, polyvinylidene fluoride (PVdF), or the like can be used. In the air battery having the structure of this embodiment, known solid electrolytes that allow only lithium ions to permeate may also be used as the material of the separator.

The oxygen permeable membrane 6 is provided for the purpose of suppressing intrusion of moisture from air and efficiently allowing oxygen to permeate therethrough. Any porous material with this function can be used. For example, zeolite can be preferably used.

The positive electrode 5 includes an aluminum porous body having a three-dimensional network structure and functioning as a positive electrode collector, and a positive electrode layer supported on the surface of the aluminum porous body. The positive electrode layer is a layer in which a catalyst and carbon are fixed with a binder, and is formed by applying a coating material onto the surface of the skeleton of the positive electrode collector. Examples of the catalyst include oxides of manganese, oxides of cobalt, nickel oxide, iron oxide, and copper oxide. Typical examples of the binder include, but are not limited to, resins such as polyvinylidene fluoride (PVdF) and polytetrafluoroethylene (PTFE).

FIG. 2 is an enlarged photograph showing an example of an aluminum porous body that has a three-dimensional network structure and that can be preferably used in the present invention. A substantially triangular prism-shaped hollow skeleton is connected three-dimensionally to form a network structure having large pores. The diameter of a pore surrounded by branches of the skeleton is typically about several tens of micrometers to 500 μm, and the skeleton is a hollow substantially triangular prism in cross section having a side of several tens of micrometers.

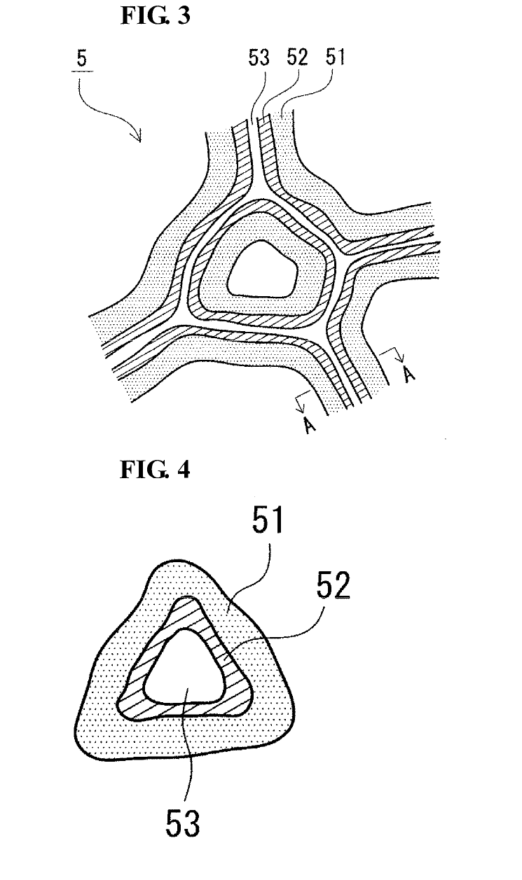

FIG. 3 is a view illustrating a structure of the positive electrode 5 including an aluminum porous body as a collector. FIG. 3 two-dimensionally illustrates the positive electrode 5 prepared by applying and supporting a positive electrode layer onto the surface of an aluminum skeleton having the structure shown in FIG. 2 as a longitudinal section along the skeleton. A skeleton 52 of the aluminum porous body has a hollow portion 53 therein and is three-dimensionally continuous. A positive electrode layer 51 is supported on the surface of the skeleton 52. The structure will be further described with reference to FIG. 4, which is a cross-sectional view taken along line A-A in FIG. 3. Specifically, FIG. 4 illustrates a cross section of a single branch of the skeleton, and illustrates that the skeleton 52 composed of aluminum is a hollow substantially triangular prism, and the positive electrode layer 51 is supported on the surface of the skeleton 52.

With this structure of the positive electrode 5, the positive electrode can have an extremely large surface area, and pores in networks are not filled with the positive electrode layer but have gaps therein, and thus oxygen can be effectively taken into the positive electrode layer. This electrode structure effectively functions not only in an air battery having a structure in which oxygen is taken as a gas into the pores but also in an air battery having a structure in which an electrolyte solution is charged on the air electrode (positive electrode) side.

Since the aluminum porous body used in the present invention has the hollow portion 53 inside the skeleton, the positive electrode is more preferably configured so that oxygen is supplied to the inside of the positive electrode through the hollow portion. The skeleton 52 can have a portion where the inside and the outside of the skeleton communicate with each other from, for example, an end portion or a pinhole in a wall surface of the skeleton. In such a portion, oxygen passing through the inside reaches the positive electrode layer and can function as an active material.

In the structure described above, as the discharging proceeds, a dissolution reaction represented by Li→Li⁺+e⁻ occurs on the surface of the metallic lithium functioning as the negative electrode, and a reaction that produces lithium oxide, the reaction being represented by O₂+4Li⁺+4e⁻→2Li₂O, occurs on the surface of the catalyst-supporting aluminum porous body functioning as the air electrode. As the charging proceeds, a precipitation reaction represented by Li⁺+e⁻→Li occurs on the surface of the metallic lithium functioning as the negative electrode, and a reaction represented by 2Li₂O→O₂+4Li⁺+4e⁻ occurs on the surface of the air electrode.

### (Production of Aluminum Porous Body)

A process for producing an aluminum porous body, which is a specific example of a metal porous body, will now be described as a typical example with reference to the drawings according to need.

### (Steps of Producing Aluminum Structure)

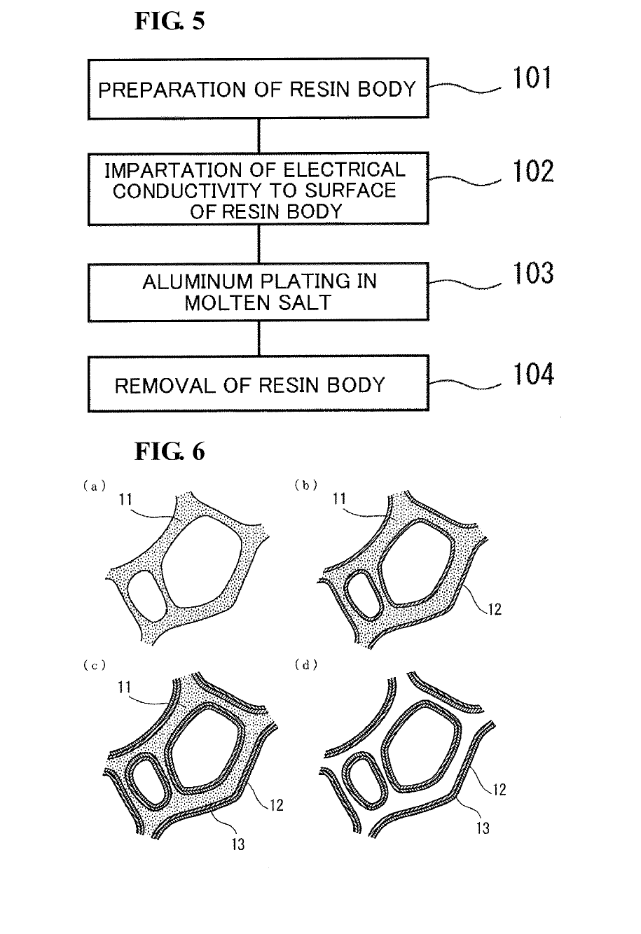

FIG. 5 is a flowchart for explaining steps of producing an aluminum structure. FIG. 6 schematically illustrates steps of forming the aluminum structure using a resin body as a core material in accordance with the flowchart. The overall flow of the production steps will be described with reference to these figures. First, preparation 101 of a resin body functioning as a base is conducted. FIG. 6(a) is an enlarged schematic view of a surface of a resin foam body having continuous pores. Pores are formed in a resin foam body 11 functioning as a skeleton. Next, impartation of electrical conductivity 102 to the surface of the resin body is conducted. In this step, a thin, electrically conductive layer 12 composed of an electrical conductor is formed on the surface of the resin body 11, as illustrated in FIG. 6(b). Subsequently, aluminum plating 103 in a molten salt is conducted to form an aluminum plating layer 13 on the surface of the resin body having the electrically conductive layer thereon (FIG. 6(c)). Thus, an aluminum structure including the resin body functioning as the base and the aluminum plating layer 13 formed on the surface of the resin body is prepared. Furthermore, removal 104 of the resin body functioning as the base may be conducted. By decomposing and eliminating the resin body 11, an aluminum structure (porous body) including only the metal layer can be obtained (FIG. 6(d)). These steps will be sequentially described below.

### (Preparation of Porous Resin Body)

As a resin body functioning as a base, a porous resin body having a three-dimensional network structure and continuous pores is prepared. Any resin can be selected as the material of the porous resin body. Examples of the material include resin foam bodies of polyurethane, melamine resin, polypropylene, polyethylene, or the like. Although the resin body is expressed as “a resin foam body”, a resin body having any shape may be selected as long as the resin body has communicating pores (continuous pores). For example, a nonwoven fabric containing tangled fibrous resin may also be used instead of the resin foam body. The resin foam body preferably has a porosity of 80% to 98% and a cell diameter of 50 to 500 μm. Polyurethane foams and melamine resin foams are preferably used as the resin foam body because they have a high porosity, continuous pores, and a good thermal decomposition property. Polyurethane foams are preferable from the standpoint of the uniformity of pores and availability. Melamine resin foams are preferable from the standpoint that a resin foam body having a small cell diameter can be obtained.

Resin foam bodies often contain residues such as a foaming agent and an unreacted monomer in the process of producing the foam. Therefore, it is preferable to perform a washing treatment before the subsequent steps. The resin body has a skeleton having a three-dimensional network structure, thereby forming continuous pores as a whole. The skeleton of a polyurethane foam has a substantially triangular shape on a cross section perpendicular to a direction in which the skeleton extends. Herein, the porosity is defined by the following formula.

Porosity=(1−(the weight of porous material [g]/(the volume of porous material [cm³]×the density of raw material))×100[%]

The cell diameter is determined by magnifying a surface of the resin body by means of a photomicrograph or the like, counting the number of pores per inch (25.4 mm) as the number of cells, and calculating the average cell diameter by the following equation:

average cell diameter=25.4 mm/the number of cells

### (Impartation of Electrical Conductivity to Surface of Resin Body)

In order to perform electrolytic plating, the surface of the resin foam is subjected to a conductive treatment in advance. The conductive treatment is not particularly limited as long as a layer having electrical conductivity can be formed by the treatment on the surface of the resin foam. It is possible to select any method such as non-electrolytic plating of a conductive metal such as nickel, vapor deposition or sputtering of aluminum or the like, or application of a conductive coating material containing conducive particles such as carbon particles.

As examples of the conductive treatment, a description will be made of a conductive treatment including a sputtering treatment of aluminum and a conductive treatment on a surface of a resin foam using carbon particles as conductive particles.

### —Sputtering of Aluminum—

A sputtering treatment using aluminum is not particularly limited as long as aluminum is used as a target, and can be performed by an ordinary method. For example, a resin foam is attached to a substrate holder, and a direct-current voltage is then applied between the holder and a target (aluminum) while an inert gas is introduced, thereby causing the ionized inert gas to collide with aluminum, and deposing sputtered aluminum particles on the surface of the resin foam. Thus, a sputtered film of aluminum is formed. The sputtering treatment is preferably conducted at a temperature at which the resin foam is not melded, specifically about 100° C. to 200° C., and preferably about 120° C. to 180° C.

### —Application of Carbon—

A carbon coating material used as a conductive coating material is prepared. A suspension as the conductive coating material preferably contains carbon particles, a binder, a dispersant, and a dispersion medium. In order to uniformly apply the conductive particles, it is necessary that the suspension maintain a uniformly suspended state. For this purpose, the suspension is preferably maintained at 20° C. to 40° C. This is because when the temperature of the suspension is lower than 20° C., the uniformly suspended state is impaired, and only the binder is concentrated on the surface of the skeleton forming the network structure of the resin foam to form a layer thereof. In this case, the applied carbon particle layer is easily separated, and it is difficult to form a metal plating layer that strongly adheres to the carbon particle layer. On the other hand, when the temperature of the suspension exceeds 40° C., the amount of dispersant evaporated is increased. Accordingly, with the lapse of the application process time, the suspension is concentrated, and the amount of carbon applied tends to vary. The carbon particles have a particle diameter of 0.01 to 5 and preferably 0.01 to 0.05 μm. When the particle diameter is excessively large, the carbon particles may clog pores of the resin foam, and disturb flat and smooth plating. When the particle diameter is excessively small, it is difficult to ensure sufficient electrical conductivity.

The carbon particles can be applied onto a porous resin body by immersing a target resin body in the suspension, and conducing squeezing and drying. An example of a practical production process will be described. First, a long sheet-like, strip-shaped resin having a three-dimensional network structure is continuously fed from a supply bobbin, and immersed in a suspension in a tank. The strip-shaped resin immersed in the suspension is squeezed with a squeeze roll to squeeze out an excessive suspension. The strip-shaped resin is then sufficiently dried by, for example, injecting hot air from a hot air nozzle to remove the dispersion medium etc. in the suspension, and then taken up with a take-up bobbin. The temperature of the hot air is preferably in the range of 40° C. to 80° C. Such an apparatus can automatically and continuously perform the conductive treatment and form a skeleton having a network structure without clogging and having a uniform electrically conductive layer, thus smoothly conducting the metal plating in the subsequent step.

### (Formation of Aluminum Layer: Molten Salt Plating)

Next, electrolytic plating is conducted in a molten salt to form an aluminum plating layer on the surface of the resin body. By conducting aluminum plating in a molten salt bath, an aluminum layer having a large thickness can be uniformly formed particularly on the surface of a complex skeleton structure, such as a resin foam body having a three-dimensional network structure. A direct current is applied between a cathode of the resin body having a surface to which electrical conductivity is imparted and an anode of aluminum having a purity of 99.0% in a molten salt. The molten salt may be an organic molten salt that is a eutectic salt of an organic halide and an aluminum halide or an inorganic molten salt that is a eutectic salt of an alkaline metal halide and an aluminum halide. Use of a bath of an organic molten salt that melts at a relatively low temperature is preferred because plating can be performed without decomposing a resin body functioning as a base. The organic halide may be an imidazolium salt or a pyridinium salt. Specifically, 1-ethyl-3-methylimidazolium chloride (EMIC) and butylpyridinium chloride (BPC) are preferred. The contamination of a molten salt by water or oxygen causes degradation of the molten salt. Therefore, plating is preferably conducted in an atmosphere of an inert gas, such as nitrogen or argon, in a sealed environment.

A bath of a molten salt containing nitrogen is preferred as the molten salt bath. Among such bathes, an imidazolium salt bath is preferably used. In the case where a salt that melts at a high temperature is used as a molten salt, the rate of dissolution or decomposition of a resin in the molten salt is higher than the rate of the growth of a plating layer, and thus a plating layer cannot be formed on the surface of the resin body. An imidazolium salt bath can be used even at a relatively low temperature without affecting a resin. A salt containing an imidazolium cation having alkyl groups at the 1- and 3-positions is preferably used as an imidazolium salt. In particular, aluminum chloride-1-ethyl-3-methylimidazolium chloride (AlCl₃-EMIC) molten salts are most preferably used because they have high stability and are not easily decomposed. Plating on a polyurethane foam or a melamine resin foam can be performed by using such an imidazolium salt bath. The temperature of the molten salt bath is in the range of 10° C. to 65° C., and preferably 25° C. to 60° C. With a decrease in the temperature, the current density range for plating becomes narrow, and plating on the entire surface of a resin body becomes more difficult. At a high temperature of more than 65° C., the shape of the resin body tends to be deformed.

With regard to molten salt aluminum plating on a metal surface, it has been reported that an additive such as xylene, benzene, toluene, or 1,10-phenanthroline may be added to AlCl₃-EMIC in order to improve the smoothness of the plated surface. The inventors of the present invention found that in aluminum plating on a resin body particularly having a three-dimensional network structure, the addition of 1,10-phenanthroline has a particular effect on the formation of the aluminum structure. More specifically, it is possible to obtain a first feature that the smoothness of the plating film is improved and the aluminum skeleton forming a porous body is tough, and a second feature that uniform plating can be achieved with a small difference in plating thickness between a surface portion and an inner portion of the porous body.

For example, in the case where a produced aluminum porous body is pressed, these two features of toughness and the uniform plating thickness in the surface portion and the inner portion can provide a porous body that has a tough skeleton as a whole and that is uniformly pressed. When an aluminum porous body is used as an electrode material of batteries or the like, an electrode filled with an electrode active material is pressed to increase the density thereof, and the skeleton tends to be broken in the filling step of the active material or during pressing. Therefore, these two features are very effective in such an application.

For the reason described above, it is preferable to add an organic solvent to a molten salt bath, and 1,10-phenanthroline is particularly preferably used. The amount of organic solvent added to the plating bath is preferably 0.2 to 7 g/L. When the amount is 0.2 g/L or less, the resulting plating layer has a poor smoothness and is brittle, and it is difficult to achieve the effect of reducing the difference in plating thickness between a surface layer and an inner portion. When the amount is 7 g/L or more, the plating efficiency is decreased and it becomes difficult to obtain a predetermined plating thickness.

An inorganic salt bath may also be used as a molten salt as long as the resin is not dissolved. A typical inorganic salt bath contains a two-component salt of AlCl₃—XCl (X: alkali metal) or a multi-component salt. Although such inorganic salt baths generally have a higher melting temperature than organic salt baths, such as a bath containing an imidazolium, the inorganic salt baths have fewer constraints of the environmental conditions, such as water and oxygen, and can be generally put to practical use at low cost. In the case where the resin is a melamine resin foam, the melamine resin foam can be used at a temperature higher than the case where a urethane foam is used, and an inorganic salt bath is used in the range of 60° C. to 150° C.

An aluminum structure including a resin body as the core material of its skeleton is produced through the above steps. In some applications, such as a filter or a catalyst support, the aluminum structure may be used as a resin-metal composite without further treatment. Alternatively, in the case where the aluminum structure is used as a resin-free metal porous body because of constraints resulting from the use environment or the like, the resin may be removed. In the present invention, in order to prevent oxidation of aluminum, the resin is removed by decomposition in a molten salt as described below.

### (Removal of Resin: Treatment in Molten Salt)

Decomposition in a molten salt is performed by the following method. A resin body having an aluminum plating layer on a surface thereof is immersed in a molten salt. The resin foam body is removed by heating while a negative potential (potential less noble than the standard electrode potential of aluminum) is applied to the aluminum layer. The application of the negative potential while the resin foam body is being immersed in the molten salt allows the decomposition of the resin foam body without oxidation of aluminum. The heating temperature can be appropriately selected in accordance with the type of resin foam body. In the case where the resin body is composed of urethane, it is necessary to control the temperature of the molten salt bath to 380° C. or higher because the decomposition occurs at about 380° C. However, the treatment should be performed at a temperature equal to or lower than the melting point (660° C.) of aluminum so as not to melt aluminum. A preferred temperature range is 500° C. or higher and 600° C. or lower. The negative potential to be applied is on the minus side of the reduction potential of aluminum and on the plus side of the reduction potential of the cation in the molten salt. This method can provide an aluminum porous body that has continuous pores, a thin surface oxide layer, and thus a low oxygen content.

An alkali metal halide salt or an alkaline earth metal halide salt may be selected as the molten salt used in the decomposition of a resin so that the aluminum electrode potential is less noble. Specifically, it is preferable to contain at least one selected from the group consisting of lithium chloride (LiCl), potassium chloride (KCl), sodium chloride (NaCl), and aluminum chloride (AlCl₃). This method can provide an aluminum porous body that has continuous pores, a thin surface oxide layer, and thus a low oxygen content.

### Example

### Formation of Electrically Conductive Layer

An example of the production of an aluminum porous body will now be specifically described. A polyurethane foam having a thickness of 1 mm, a porosity of 95%, and the number of pores (number of cells) per inch of about 50 was prepared as a resin foam body and was cut into a 100 mm×30 mm square. The polyurethane foam was immersed in a carbon suspension and then dried to form an electrically conductive layer, the entire surface of which had carbon particles applied thereon. The suspension contained, as components, 25% by mass of graphite and carbon black, a resin binder, a penetrant, and an antifoamer. The carbon black had a particle diameter of 0.5 μm.

### (Molten Salt Plating)

The polyurethane foam having the electrically conductive layer on the surface thereof was attached, as a workpiece, to a jig having an electricity supply function. The polyurethane foam was then placed in a glove box in an argon atmosphere at a low humidity (a dew point of −30° C. or lower) and was immersed in a molten salt aluminum plating bath (33% by mole EMIC-67% by mole AlCl₃) at a temperature of 40° C. The jig holding the workpiece was connected to the cathode of a rectifier, and an aluminum plate (purity 99.99%) of the counter electrode was connected to the anode. A direct current was applied at a current density of 3.6 A/dm² for 90 minutes to perform plating, thus obtaining an aluminum structure in which 150 g/m² of an aluminum plating layer was formed on the surface of the polyurethane foam. Stirring was conducted with a stirrer using a Teflon (registered trademark) rotor. The current density was calculated on the basis of the apparent area of the polyurethane foam.

A sample of a skeleton portion of the resulting aluminum structure was extracted, cut along a cross section perpendicular to a direction in which the skeleton extends, and observed. The cross section had a substantially triangular shape, which reflected the structure of the polyurethane foam used as a core material.

### (Decomposition of Resin Foam Body)

The aluminum structure was immersed in a LiCl—KCl eutectic molten salt at a temperature of 500° C., and a negative potential of −1 V was applied to the aluminum structure for 30 minutes. Air bubbles resulting from a decomposition reaction of the polyurethane were generated in the molten salt. Subsequently, the structure was cooled to room temperature in the atmosphere and was then washed with water to remove the molten salt, thus obtaining an aluminum porous body from which the resin had been removed. FIG. 3 shows an enlarged photograph of the aluminum porous body. The aluminum porous body had continuous pores and had a high porosity as in the polyurethane foam used as the core material.

The aluminum porous body was dissolved in aqua regia, and the resulting sample was measured with an inductively-coupled plasma (ICP) emission spectrometer. The aluminum purity was 98.5% by mass. The carbon content was measured by an infrared absorption method after combustion in a high-frequency induction furnace in accordance with JIS-G1211. The carbon content was 1.4% by mass. Furthermore, a surface of the aluminum porous body was analyzed by energy dispersive X-ray spectroscopy (EDX) at an accelerating voltage of 15 kV. According to the result, peaks due to oxygen were negligible, indicating that the oxygen content of the aluminum porous body was lower than the detection limit (3.1% by mass) of EDX.

### (Formation of Air Battery)

The aluminum porous body, which is a metal porous body having a three-dimensional network structure, was used as a positive electrode collector. The aluminum porous body was filled with a coating material containing carbon black, a MnO₂ catalyst, a PVdF binder, and N-methylpyrrolidone (NMP), dried, and punched into a diameter φ of 16 mm to prepare a positive electrode. A positive electrode active material is oxygen in air. As an electrolyte solution, 1M—LiClO₄/propylene carbonate (PC) (5 mL) was used. A porous propylene separator having a diameter φ of 18 mm was used as a separator. Metallic lithium was used as a negative electrode. As Comparative Example, a battery having the same structure as this Example was prepared except that carbon paper was used as the collector. According to the measurement results of the internal resistance, the internal resistance in Example was 189Ω, and the internal resistance in Comparative Example was 298Ω. Thus, the internal resistance could be reduced.

### REFERENCE SIGNS LIST

1 negative electrode collector
2 negative electrode active material
3 electrolyte solution
4 separator
5 positive electrode
6 oxygen permeable membrane
10 air battery
11 resin foam body
12 electrically conductive layer
13 aluminum plating layer
51 positive electrode layer
52 skeleton
53 hollow portion

1. An air battery that uses oxygen as a positive electrode active material, the air battery comprising an aluminum porous body having a three-dimensional network structure, the aluminum porous body functioning as a positive electrode collector.

2. The air battery according to claim 1, wherein a positive electrode including a positive electrode layer provided on a surface of a skeleton of the aluminum porous body is used.

3. The air battery according to claim 2, wherein the positive electrode is a porous body electrode having continuous pores in a state where the positive electrode layer is provided on the surface of the skeleton of the aluminum porous body.

4. The air battery according to claim 1, wherein the aluminum porous body has a continuous hollow portion inside the skeleton thereof.

5. The air battery according to claim 1, wherein the aluminum porous body has a porosity of 90% or more and less than 99%.

6. The air battery according to claim 2, wherein the positive electrode layer has a thickness of 1 μm or more and 50 μm or less.

7. The air battery according to claim 1, wherein metallic lithium is used as a negative electrode active material.

8. The air battery according to claim 1, wherein lithium titanate is used as a negative electrode active material, and an aluminum porous body having a three-dimensional network structure is used as a negative electrode collector.

9. An electrode used in an air battery, the electrode comprising a collector composed of an aluminum porous body having a three-dimensional network structure and a positive electrode layer supported on a surface of the collector.

10. The electrode according to claim 9, wherein the electrode is a porous body electrode having continuous pores in a state where the positive electrode layer is provided on the surface of a skeleton of the aluminum porous body.

11. The electrode according to claim 9, wherein the aluminum porous body has a continuous hollow portion inside the skeleton thereof.

12. The electrode according to claim 9, wherein the aluminum porous body has a porosity of 90% or more and less than 99%, and the positive electrode layer has a thickness of 1 μm or more and 50 μm or less.
